(19) United States
(12) Patent Application Publication
(10) Pub. No.: US 2007/0227563 A1
(43) Pub. Date: Oct. 4, 2007

(54) Cleaning apparatus and cleaning method

(75) Inventors: Hirokazu Yamamoto, Kanagawa (JP); Akiko Hashi, Kanagawa (JP); Yoshio Yamamoto, Tokyo (JP); Katsuhiro Ota, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B. V., Amsterdam (NL)

(21) Appl. No.: 11/732,466

(22) Filed: Apr. 2, 2007

(30) Foreign Application Priority Data
Apr. 4, 2006 (JP) 2006-103316

(51) Int. Cl. B08B 3/00; B08B 3/12

(52) U.S. Cl. 134/34; 134/184

(57) ABSTRACT

Embodiments in accordance with the present invention provide straightening plates at the upstream side of a cleaning tank and a straightening plate at the downstream side of the object to be cleaned. Apertures are arranged in the planes of the respective straightening plates. An aperture ratio of the upstream straightening plates is set larger than the ratio of the downstream straightening plate. For example, the aperture ratio of the upstream straightening plate may be set at a value between 10% and 25%, and the aperture ratio of the downstream straightening plate is set at a value between 2.5% and 10%. With this, the flow of liquid in the cleaning chamber sandwiched between the upstream and downstream straightening plates can be brought to a pseudo-laminar flow. Contaminants separated from the object to be cleaned are moved quickly to the discharge chamber and are removed by a filter.

### CROSS-REFERENCE TO RELATED APPLICATION

The instant nonprovisional patent application claims priority to Japanese Patent Application 2006-103316, filed Apr. 4, 2006 and incorporated by reference in its entirety herein for all purposes.

### BACKGROUND OF THE INVENTION

To remove dust and contaminants adhering to precision machine parts such as a head stack assembly (HSA), cleaning treatments use a liquid such as pure water. Conventional batch type cleaning apparatuses include a cleaning apparatus having a structure in which a straightening plate having many small apertures formed therein is placed on the bottom of a cleaning tank. A carrier holding an object to be cleaned is placed on the straightening plate. Cleaning liquid is flowed from the bottom to the top of the cleaning tank. A cleaning apparatus having this structure has been disclosed, for example, in JP-A 58-48423 (patent document 1). Conventionally, a straightening plate has apertures formed uniformly. The patent document 1, however, has disclosed a cleaning apparatus that makes apertures in a portion, opposed to an object to be cleaned, in a straightening plate larger than apertures in the other portion in order to flow cleaning liquid efficiently at the position of the object to be cleaned, thereby reducing the required amount of the cleaning liquid and improving a cleaning effect.

JP-A 4-56321 (patent document 2) and JP-A 1-57721 (patent document 3) described below, also have disclosed cleaning apparatuses that flow cleaning liquid up and down. In particular, the cleaning apparatus disclosed in patent document 2 has a plurality of straightening plates arranged in the bottom of a cleaning tank and forms a uniform flow from the bottom to the top of the cleaning tank to clean an object to be cleaned uniformly.

JP-A 8-332465 (patent document 4) has disclosed a cleaning apparatus that flows cleaning liquid in a horizontal direction in a cleaning tank. In this cleaning apparatus, a flow in a horizontal direction is formed by straightening plates arranged on the upstream side and the downstream side of the cleaning tank. In order to prevent re-contamination during cleaning, an object to be cleaned is moved in the cleaning tank from the down stream side, where the degree of contamination of cleaning liquid is higher, to the upstream side where the degree of contamination of cleaning liquid is lower.

Like the cleaning apparatus disclosed in the patent documents 1 to 3, in the construction in which the cleaning liquid is flowed from the bottom to the top, the cleaning liquid near the liquid level of the cleaning tank has a higher degree of contamination than the cleaning liquid near the bottom because of contaminants that are separated from the object to be cleaned. For this reason, when the object has been cleaned and is pulled up from the cleaning liquid and taken out of the cleaning tank, the object is passed through an upper layer portion of the cleaning liquid having the higher degree of contamination. This presents a problem in that contaminants are easily deposited again on the object to be cleaned. Moreover, in the construction in which the cleaning liquid is flowed from the bottom to the top, heavy contaminants are hard to reach to the top of the cleaning tank from which the cleaning liquid is discharged. Thus, this presents a problem that the heavy contaminants are easily collected in the cleaning tank and are easily deposited again on the object to be cleaned.

Here, in the construction of flowing the cleaning liquid in the horizontal direction like the cleaning apparatus disclosed in the patent document 4, it is possible to avoid the above-mentioned problem. However, when the flow of the cleaning liquid in the cleaning tank is not or not close to a laminar flow, the contaminants separated from the object to be cleaned cannot be discharged quickly from the downstream side of the cleaning tank, but can remain in the cleaning tank. Thus, the problem of re-deposition of the contaminants easily arises again.

For example, as is in the case of the cleaning apparatus described in an embodiment of the patent document 4, when cleaning liquid flows over the top end of a downstream straightening plate and flows down into a discharge tank provided outside the cleaning tank, the velocity of flow near the liquid level of the cleaning tank becomes faster than the velocity of flow near the bottom surface of the cleaning tank. This difference in the velocity of flow causes a back flow toward the upstream side of the flow, so the concentration of the contaminants in the cleaning tank becomes higher. Thus, this can raise a problem of re-deposition of the contaminants.

Moreover, when an increase in the concentration of contaminants caused by the back flow is substantially limited to within a specified distance from the downstream straightening plate, if the object to be cleaned is placed in a portion closer to the upstream side, it is possible to avoid the problem of re-deposition of the contaminants. However, this requires elongating the length of the cleaning tank and hence presents a problem of enlarging the size of the cleaning apparatus.

Therefore it is desirable to provide a cleaning apparatus and a cleaning method for preventing contaminants from being deposited again on an object to be cleaned by a simple construction.

### BRIEF SUMMARY OF THE INVENTION

Embodiments in accordance with the present invention provide a flow of a cleaning liquid between an upstream straightening plate and a downstream straightening plate that is brought to a pseudo-laminar flow in which swirls and stagnant pools are suitably prevented. With this, contaminants separated from the object to be cleaned are discharged quickly from the passing apertures of the downstream straightening plate, thereby being prevented from being deposited again on the object to be cleaned.

In a cleaning apparatus, contaminants once separated from an object to be cleaned can be deposited again on the object to be cleaned when turbulence occurs in the flow of cleaning liquid. However, in the specific embodiment of the present invention shown in FIG. 1, cleaning liquid is flowed by a pump 4 in a given direction in a cleaning tank 2. Two straightening plates 20 are arranged on the upstream side of cleaning tank 2 and a straightening plate 22 is arranged on the downstream side of the object to be cleaned. A plurality of apertures are arranged in the planes of the respective straightening plates. As for an aperture ratio that is a proportion of area of the apertures in the straightening plate, the aperture ratio of the upstream straightening plates 20 is set larger than the aperture ratio of the downstream straightening plate 22. For example, the aperture ratio of the upstream straightening plate 20b is may be set at a value between 10% or more and 25% or less, and the aperture ratio of the downstream straightening plate 22 is set at a value between 2.5% and 10%. With this, the flow of liquid in the cleaning chamber 28 sandwiched between the upstream and downstream straightening plates 20b and 22 can be brought to a pseudo-laminar flow. Contaminants separated from the object to be cleaned are moved quickly to the discharge chamber 26 and are removed by a filter 6.

According to an embodiment of the present invention, a cleaning apparatus includes: a cleaning tank that stores cleaning liquid flowing in a given direction and has such an object to be cleaned as is dipped in the cleaning liquid; a plurality of upstream straightening plates that are arranged opposite to each other with a spacing between them on the upstream side of a position where the object to be cleaned is placed and each of which has a plurality of upstream passing apertures for passing the cleaning liquid arranged in its plane; and a downstream straightening plate that is arranged on the downstream side of the position where the object to be cleaned is placed and has a plurality of downstream passing apertures for passing the cleaning liquid arranged in its plane, and is characterized in that an upstream aperture ratio that is a proportion of area of the upstream passing apertures in the upstream straightening plate is larger than a downstream aperture ratio that is a proportion of area of the downstream passing apertures in the downstream straightening plate, the upstream aperture ratio being set at a value of 10% or more and 25% or less, the downstream aperture ratio being set at a value of 2.5% or more and 10% or less.

According to another embodiment of the present invention, a cleaning method for flowing cleaning liquid in a given direction to clean such an object to be cleaned as is dipped in the cleaning liquid, includes the steps of: flowing the cleaning liquid through a plurality of upstream passing apertures arranged in a plane of a plurality of upstream straightening plates that are arranged on the upstream side of a liquid flow of the cleaning liquid and vertically to the liquid flow; flowing the cleaning liquid through a plurality of downstream passing apertures arranged in respective planes of a downstream straightening plate that is arranged on the downstream side of a liquid flow of the cleaning liquid and vertically to the liquid flow; and dipping the object to be cleaned in a liquid flow of the cleaning liquid formed between the upstream straightening plate and the downstream straightening plate, and is characterized in that the plurality of upstream straightening plates are arranged opposite to each other with a spacing between them, and in that an upstream aperture ratio that is a proportion of area of the upstream passing apertures in the upstream straightening plate is larger than a downstream aperture ratio that is a proportion of area of the downstream passing apertures in the downstream straightening plate, the upstream aperture ratio being set at a value of 10% or more and 25% or less, the downstream aperture ratio being set at a value of 2.5% or more and 10% or less.

For a more complete understanding of the present invention, reference is made to the following detailed description taken in conjunction with the accompanying drawings.

### BRIEF DESCRIPTION OF THE DRAWINGS

FIG. 1 is a schematic diagram to show the structure of an HSA cleaning apparatus used when an HSA or its constituent parts are cleaned according to an embodiment of the present invention.

FIG. 2 is a schematic sectional view of an upstream straightening plate of constructed of two plates according to an embodiment of the present invention.

FIG. 3 is a schematic sectional view of an upstream straightening plate of constructed of three plates according to an embodiment of the present invention.

FIG. 4 is a graph to show the relationship between the coefficient of kinetic viscosity of liquid and the suitable diameters of circular apertures formed in the straightening plate according to an embodiment of the present invention.

FIG. 5 is a schematic plan view of a cleaning apparatus in which a plurality of cleaning tanks are arranged in parallel according to an embodiment of the present invention.

### DETAILED DESCRIPTION OF THE INVENTION

Embodiments in accordance with the present invention relate to a cleaning apparatus and a cleaning method for cleaning precision machine parts such as a head stack assembly (HSA) of a magnetic disc device, semiconductor wafers, semiconductor devices, and the like by the use of liquid.

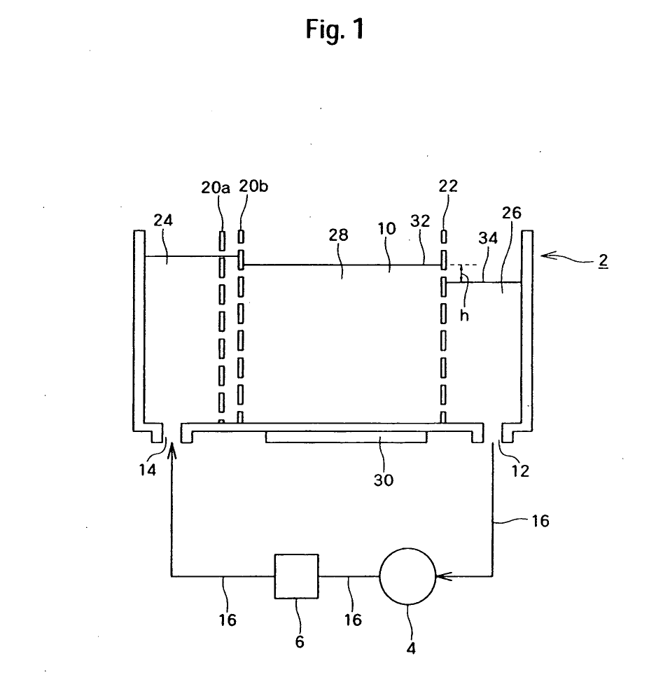

FIG. 1 is a schematic diagram to show the structure of a cleaning apparatus for an HSA used at the time of cleaning an HSA or its constituent parts according to an embodiment of the present invention. This cleaning apparatus constructs a cleaning liquid recirculation circuit constructed of a cleaning tank 2, a pump 4, and a filter 6. FIG. 1 shows the recirculation circuit and a vertical sectional view of the cleaning tank 2 in a direction along the flow of the cleaning liquid.

Pure water, for example, is stored as cleaning liquid 10 in the cleaning tank 2. A discharge port 12 of cleaning liquid 10 is provided on one end of the cleaning tank 2 and a supply port 14 of cleaning liquid 10 is provided on the other end. The suction port of the pump 4 is connected to the discharge port 12, and the delivery port of the pump 4 is connected to the supply port 14 via the filter 6. Incidentally, the discharge port 12 is connected to the pump 4 by a pipe 16, the pump 4 is connected to the filter 6 by the pipe 16, and the filter 6 is connected to the supply port 14 by the pipe 16, respectively.

The pump 4 sucks cleaning liquid through the discharge port 12 and discharges the cleaning liquid toward the filter 6. The filter 6 filters out contaminants of the cleaning liquid, and the cleaning liquid passing through the filter 6 flows into the cleaning tank 2 through the supply port 14. With this, a horizontal flow from an end provided with the supply port 14 to an end provided with the discharge port 12 develops in the cleaning tank 2.

A plurality of straightening plates are arranged on the upstream side of the flow of the cleaning liquid 10 in the cleaning tank 2. For example, two straightening plates 20a, 20b are arranged on the upstream side in this apparatus. Moreover, one straightening plate 22 is arranged also on the downstream side of the cleaning tank 2. Here, the upstream straightening plates 20a, 20b are arranged at a downstream position of the supply port 14, and the straightening plate 20b is arranged on the downstream side of and close to the straightening plate 20a. Moreover, the downstream straightening plate 22 is arranged on the upstream side of the discharge port 12. The respective straightening plates 20a, 20b, and 22 are arranged vertically to the flow.

The cleaning tank 2 is partitioned into three spaces by the upstream straightening plates 20a, 20b, and the downstream straightening plate 22. Here, of the spaces in the cleaning tank 2, a space on the upstream side of the straightening plate 20a is referred to as a supply chamber 24 of the cleaning liquid, a space on the downstream side of the straightening plate 22 is referred to as a discharge chamber 26 of the cleaning liquid, and a space between the straightening plate 20b and the straightening plate 22 is referred to as a cleaning chamber 28.

An object to be cleaned such as an HSA is dipped in the cleaning chamber 28 and has contaminants removed by the cleaning liquid. In one embodiment, ultrasound generating unit 30 is mounted on the outside wall of the cleaning chamber 28 to apply ultrasonic vibrations to the cleaning liquid 10 in the cleaning chamber 28 in order to accelerate the separation of contaminants from the object to be cleaned. Moreover, this apparatus is provided with an element (not shown) for heating the cleaning liquid 10. The separation of contaminants from the object to be cleaned can be accelerated by heating the cleaning liquid 10 by the element. For example, the cleaning liquid 10 is heated to about 50° C. to 75° C.

This apparatus is devised in such a way that the laminar flow of cleaning liquid is ideally formed in this cleaning chamber 28 to quickly discharge contaminants, separated from the object to be cleaned from the cleaning chamber 28, to a discharge chamber 26 to thereby reduce the contaminants deposited again on the object to be cleaned. In reality, it is difficult to realize a complete laminar flow. However, it is possible to realize a pseudo-laminar flow having a swirl and a stagnant pool suitably suppressed and having a uniform velocity distribution, and thus is substantially assumed to be a laminar flow. In the following description, expressions of a straightened flow and a uniform flow mean a pseudo-laminar flow.

In order to form a straightened flow, the inside wall of the cleaning chamber 28 is constructed in parallel to the direction of the flow of the cleaning liquid 10. For example, the cleaning tank 2 is constructed in the shape of a rectangular solid.

Moreover, the straightening plates 20a, 20b, and 22 play a role in straightening the flow of cleaning liquid in the cleaning chamber 28. The respective straightening plates have many apertures formed therein. For example, many apertures are arranged two-dimensionally at specified intervals in the respective straightened plates.

Two upstream straightening plates 20 are arranged apart from each other between the supply chamber 24 and the cleaning chamber 28. Generally, a swirl and a velocity distribution and a pressure distribution arising from the flow from the supply port 14 are caused in the cleaning liquid 10 in the supply chamber 24. The construction of employing a plurality of straightening plates 20 makes the flow of the cleaning liquid 10 flowing in from the supply chamber 24 more uniform than a construction employing only one straightening plate 20.

The plurality of straightening plates 20 stepwise improve the nonuniform flow of the cleaning liquid 10 in the supply chamber 24, and a straightened flow is outputted from the straightening plate 20b to the cleaning chamber 28. In one embodiment, the shapes and areas of the plurality of apertures formed in the first straightening plate 20a and the shapes and areas of the second straightening plate 20b are made fundamentally uniform and are made identical to each other. In another embodiment, in the second straightening plate 20b the apertures formed in a portion close to the wall of the cleaning tank 2 are made different in the shape and area from the apertures formed in a portion away from the wall so as to reflect the influence of resistance that the cleaning liquid 10 receives from the wall.

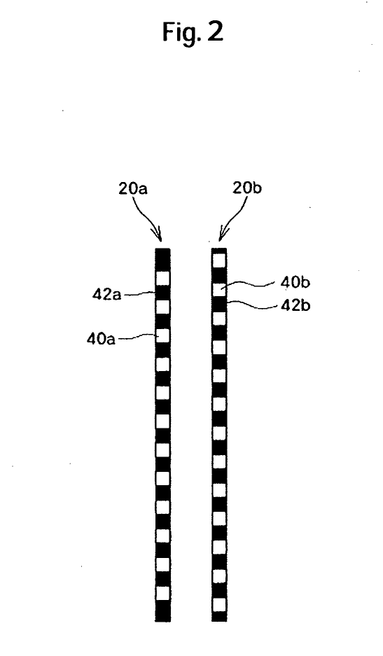

The apertures formed in the respective straightening plates 20 adjacent to each other are arranged so as to be shifted in position between both of the straightening plates 20. FIG. 2 is a schematic sectional view of the straightening plates 20a and the straightening plates 20b according to an embodiment of the present invention. As shown in FIG. 2, the apertures 40a of the straightening plate 20a are arranged opposite to the plate material 42b of the straightening plate 20b. Apertures 40b of the straightening plate 20b are arranged opposite to the plate material 42a of the straightening plate 20a. For example, it is possible to make the arrangement of the apertures of the straightening plate 20a and the arrangement of the apertures of the straightening plate 20b as two-dimensionally periodic common arrangement patterns which are shifted in position from each other. This construction in which two adjacent straightening plates 20 are not identical to each other in the positions of apertures prevents the flows of the cleaning liquid 10 passing through the apertures 40a of the straightening plate 20a from passing directly through the apertures 40b of the straightening plate 20b. With this, the nonuniform flow of the cleaning liquid 10 in the supply chamber 24 affects the cleaning chamber 28 to a lesser extent, and the uniformity of the flow outputted from the straightening plate 20b is improved.

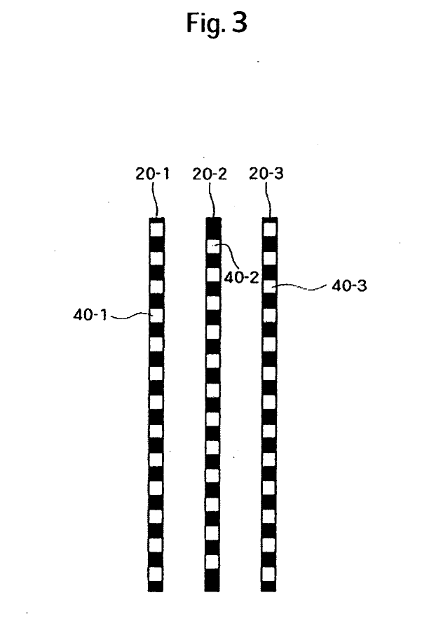

It is also possible to employ the construction in which three or more straightening plates 20 are arranged between the supply chamber 24 and the cleaning chamber 28. FIG. 3 is a schematic sectional view of three straightening plates 20 arranged between the supply chamber 24 and the cleaning chamber 28 according to an embodiment of the present invention. As shown in FIG. 3, apertures 40-1 and 40-2 formed in the first straightening plate 20-1 and the second straightening plate 20-2, which are adjacent to each other, are shifted in position from each other; and apertures 40-2 and 40-3 formed in the second straightening plate 20-2 and the third straightening plate 20-3, which are adjacent to each other, are shifted in position from each other.

The respective straightening plates 20 are formed in a relatively thin thickness, for example, of several mm. Further, the straightening plates 20 are formed of material that is not degraded in the cleaning liquid 10 at a relatively high temperature as described above and is not deformed by hydraulic pressure. In one embodiment, the straightening plates 20 of this apparatus are formed of stainless steel having corrosion resistance.

The sizes of the uniform apertures formed in the straightening plate 20b are determined according to the viscosity of the cleaning liquid 10. In one embodiment, the cleaning liquid 10 of this apparatus is pure water or liquid having the same viscosity as pure water. The coefficient of kinematic viscosity of pure water is 0.00478 cm2/sec, and in correspondence with this, for example, circular apertures of 5 mm in diameter are arranged in the straightening plate 20b. A proportion of the areas of the apertures in the straightening plate 20b, that is, an aperture ratio of the straightening plate 20b, is set within a range from 10% to 25% in which a straightened flow is realized. For example, in an arrangement pattern in which apertures are formed at intersections of a square lattice, the pitch of arrangement of the apertures is set at from about 5 mm to about 15 mm in terms of the spacing between the centers of the apertures. Here, the above-mentioned upper limit of the range of the aperture ratio is determined in consideration of the strength of the straightening plate 20b.

In one embodiment, the sizes and arrangement pattern of apertures formed in the straightening plate 20a are the same as those of the straightening plate 20b.

The flow of the cleaning liquid 10 flowing from the supply chamber 24 into the cleaning chamber 28 is made uniform by the plurality of straightening plates 20 described above. The straightened flow outputted from the straightening plates 20 flows downstream in the cleaning chamber 28 and reaches a downstream straightening plate 22 constructing the boundary between the cleaning chamber 28 and the discharge chamber 26.

The downstream straightening plate 22 has many apertures formed therein, as described above. The shapes and areas of the plurality of apertures formed in the straightening plate 22 are made fundamentally uniform so that the cleaning liquid 10 is discharged to the discharge chamber 26 while keeping uniformity in the cleaning chamber 28. In one embodiment of the straightening plate 22 as in an embodiment of the straightening plate 20b, the apertures formed in a portion close to the wall of the cleaning tank 2 are different in the shape and area from the apertures formed in a portion away from the wall. Moreover, the straightening plate 22 may also be formed of the same stainless steel as in the case of the straightening plate 20.

The sizes of the uniform apertures formed in the straightening plate 22 are also determined according to the viscosity of the cleaning liquid 10 as in the case of the straightening plate 20b. In one embodiment, in correspondence with the circular apertures of about 5 mm in diameter of the above-mentioned straightening plates 20b, for example, circular apertures of 3 mm in diameter are formed in the straightening plate 22. In one aspect, in order to realize the straightened flow, the aperture ratio of the straightening plate 22 is set smaller than the aperture ratio of the straightening plate 20b and is set within a range of 2.5% to 10%. For example, in the arrangement pattern in which apertures are arranged at the respective intersections of a square lattice, the pitch of arrangement of the apertures is set at about 5 mm to about 15 mm in terms of the spacing between the centers of the apertures.

When the cleaning liquid 10 reaching the straightening plate 22 passes through the apertures formed in the straightening plate 22, the velocity of flow increases. As a result, negative pressure is produced by a Bernoulli's effect in regions of the apertures close to the cleaning chamber 28, whereby the cleaning liquid 10 in the regions is drawn into the apertures. In one embodiment, the aperture ratio of the straightening plate 22 is set smaller than the aperture ratio of the straightening plate 20, so the effect of Bernoulli's effect in the regions close to the straightening plate 22 is strengthened. The flow hitting the straightening plate 22 causes back flows and stagnant pools to easily impair the straightened flow in the cleaning chamber 28. In one aspect, by strengthening the drawing of the cleaning liquid 10 into the apertures near the straightening plate 22, this problem is avoided; and the contaminants flowing to the downstream side of the cleaning chamber 28 can be effectively discharged to the discharge chamber 26.

As shown also in FIG. 1, a drop is caused between a liquid level 32 on the upstream side of the downstream straightening plate 22 and a liquid level 34 on the downstream side thereof. This is because a difference is caused in the aperture ratio between the upstream straightening plate 20 and the downstream straightening plate 22. In other words, the conductance of the downstream straightening plate 22 for determining the amount of outflow of the cleaning liquid to the downstream side of the downstream straightening plate 22, that is, to the discharge chamber 26, is smaller than the conductance of the upstream straightening plate 20 for determining the amount of inflow of the cleaning liquid to the upstream side of the downstream straightening plate 22, that is, to the cleaning chamber 28. By making the liquid level 32 on the upstream side higher than the liquid level 34 on the downstream, the hydraulic pressure on the upstream side of the downstream straightening plate 22 is increased and hence the velocities of flows of the cleaning liquid passing through the apertures of the downstream straightening plate 22 are increased. These velocities of flows are increased with the drop “h”, and the flow rate of the cleaning liquid passing through the downstream straightening plate 22 is increased by an increase in the velocities of flows. The drop “h” is determined so as to balance the amount of inflow of the cleaning liquid to the cleaning chamber 28 against the amount of outflow of the cleaning liquid to the discharge chamber 26.

Here, the velocity of flow on the upstream side of the downstream straightening plate 22 becomes faster in a portion higher than the liquid level 34 than in a portion lower than the liquid level 34 and becomes faster in a portion closer to the liquid level 32. The distribution of the velocity of flow can cause back flows on the upstream side of the downstream straightening plate 22 and can impair the uniformity of the flow of the cleaning liquid. For this reason, to realize a straightened flow, it is preferable that the drop “h” is relatively small, and it was found from the experiment using pure water that the drop h of about 30 mm or less was suitable. Thus, in one embodiment, this cleaning apparatus is constructed so as to reduce the drop h to about 30 mm or less. In one aspect, the above-mentioned difference in the aperture ratio between the upstream straightening plate 20 and the downstream straightening plate 22 may be determined in consideration of this condition. In this regard, the drop “h” may be changed according to the properties of the cleaning liquid, such as viscosity. The usually used cleaning liquid can be considered to be the same in this point as water, and hence conditions regarding the drop “h” may fundamentally be identical to those of water.

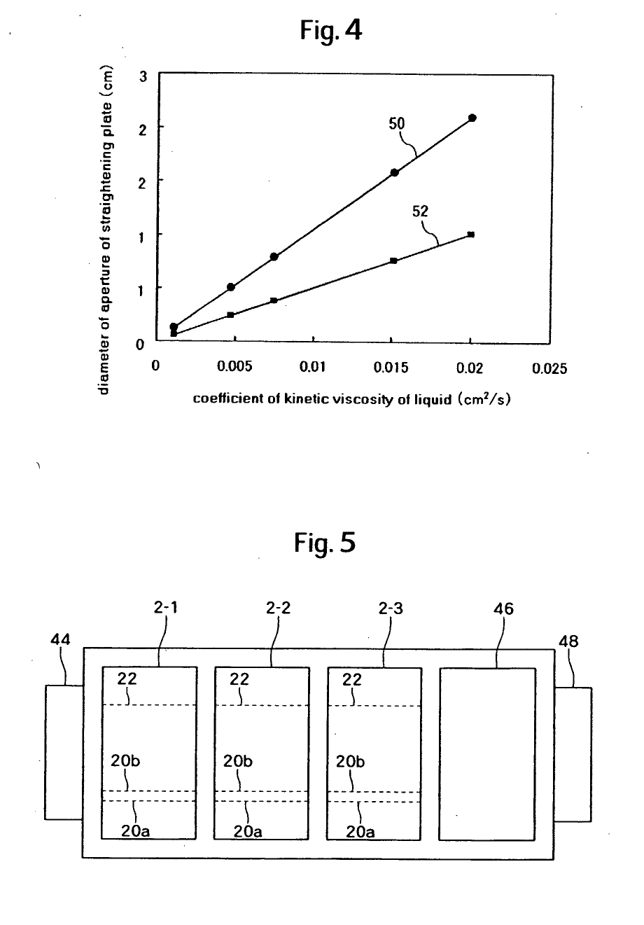

As described above, the sizes of the apertures formed in the straightening plates 20, 22 are set in consideration of the viscosity of liquid used as the cleaning liquid. FIG. 4 is a graph to show the relationship between the coefficient of kinetic viscosity of liquid and the suitable diameter of a circular aperture formed in the straightening plate according to an embodiment of the present invention. A characteristic 50 shows a relationship relating to the upstream straightening plate 20 and a characteristic 52 shows a relationship relating to the downstream straightening plate 22.

The coefficient of kinetic viscosity of pure water is 0.00478 cm2/sec, as described above, and in correspondence with this, the diameters of the apertures of the upstream straightening plate 20b and the downstream straightening plate 22 are set at about 5 mm and 3 mm, respectively. When the coefficient of kinetic viscosity is 0.0075 cm²/sec, which corresponds to the coefficient of kinetic viscosity of benzol, the suitable diameters of the apertures of the respective straightening plates become about 8 mm and 4 mm. Moreover, when the coefficient of kinetic viscosity is 0.0151 cm2/sec, which corresponds to the coefficient of kinetic viscosity of alcohol, the suitable diameters of the apertures of the respective straightening plates become about 16 mm and 8 mm. In this regard, the suitable diameters of the apertures of the respective straightening plates change according to the coefficient of kinetic viscosity, but the respective aperture ratios of the upstream straightening plate 20b and the downstream straightening plate 22 can be kept at specified values by adjusting the pitches of arrangement of the apertures.

Here, when the suitable conditions are determined, the degree of uniformity of the flow was determined by observing the flow visualized by dripping ink into the cleaning tank 2.

Moreover, at the time of determining the suitable diameter of the aperture, a downstream straightening plate 22 having a structure capable of changing the areas of the passing apertures was used. This downstream straightening plate 22 is constructed of two element plates whose one surfaces are in contact with each other and includes a mechanism for sliding one element plate with respect to the other element plate. The respective element plates have a plurality of apertures formed at the same positions, and the areas of portions overlapping the apertures of both element plates can be changed by sliding the one element plate with respect to the other element plate. The portions overlapping the apertures of both element plates become the passing apertures of the downstream straightening plate 22. The area of the passing aperture of the downstream straightening plate 22 for realizing a suitable uniform flow with respect to the aperture diameter of about 5 mm of the upstream straightening plate 20b was found, and the diameter of the circular aperture of the downstream straightening plate 22 was determined on the basis of this area.

A gimbals of a magnetic disc device disclosed in JP-A 2000-135501 were cleaned by the use of this cleaning apparatus to examine the cleaning capacity of this apparatus. Before cleaning, stainless steel particles of 1 μm in average diameter were deposited as the model of contaminants on a slider mounted on the tip portion of the gimbals. One hundred gimbals like this were housed in a carrier and were dipped along with the carrier in the cleaning liquid in the cleaning chamber 28 and were subjected to cleaning treatment. Here, the carrier had a plurality of cells arranged two-dimensionally, and the respective cells were constructed so as to flow the cleaning liquid, and the gimbals of the objects to be cleaned were housed individually in the respective cells of the carrier. The measurement result by an optical microscope revealed that the number of particles deposited on the respective sliders was 10 to 15 before cleaning and was reduced to 0 to 1 after cleaning. Thus, an excellent cleaning effect of preventing the re-deposition of the contaminants could be verified.

Moreover, this cleaning apparatus may be constructed so as to include a plurality of cleaning tanks 2. FIG. 5 is a schematic plan view, when viewed from the top, of a cleaning apparatus having a plurality of cleaning tanks 2 arranged in parallel according to an embodiment of the present invention. In this construction, for example, three cleaning tanks 2-1 to 2-3 are arranged in a line, and a loader 44 is arranged on one side of the line and a drying unit 46 and an unloader 48 are arranged on the other side of the line. For example, the loader 44 picks up objects waiting to be cleaned in order and dips them in the vacant cleaning tank 2. The unloader 48 pulls up the objects to be cleaned, which have finished being cleaned, from the cleaning tank 2 and moves them to the drying unit 46. The drying unit 46 dries the objects to be cleaned, which have finished being cleaned, by a method of blowing dry air or the like. The objects to be cleaned, which have finished being dried by drying unit 46, are moved by the unloader 48 to post treatment. With this construction, the cleaning of the objects to be cleaned can be performed in parallel by the use of the plurality of cleaning tanks 2. Moreover, as the construction in which the objects to be cleaned are moved in order of the cleaning tanks 2-1 to 2-3 by the use of the loader 44 and the unloader 48, it is also possible to perform cleaning treatment in order by different cleaning liquid for each of the cleaning tanks 2 or to perform rinse treatment using pure water after performing cleaning treatment using cleaning liquid containing a surface active agent.

While the above-mentioned cleaning apparatus flows the cleaning liquid in a horizontal direction, the present invention can be applied also to a cleaning apparatus that flows cleaning liquid in a vertical direction. For example, by setting the aperture ratio of a plurality of upstream straightening plates arranged horizontally in the bottom of the cleaning tank and the aperture ratio of a plurality of downstream straightening plates arranged horizontally in the top of the cleaning tank to within a suitable range, the straightened flow of the cleaning liquid flowing from the bottom to the top of the cleaning tank can be suitably realized.

While the cleaning of the HSA and its parts has been described by way of example in the above embodiment, the cleaning apparatus according to the present invention can be applied to the cleaning of precision machine parts, semiconductor wafers, and various kinds of electronic parts using electronic material, magnetic material, optical material, ceramics, and the like.

While the present invention has been described with reference to specific embodiments, those skilled in the art will appreciate that different embodiments may also be used. Thus, although the present invention has been described with respect to specific embodiments, it will be appreciated that the present invention is intended to cover all modifications and equivalents within the scope of the following claims.

What is claimed is:

1. A cleaning apparatus comprising:
a cleaning tank that stores cleaning liquid flowing in a given direction and has such an object to be cleaned as is dipped in the cleaning liquid;
a plurality of upstream straightening plates that are arranged opposite to each other with a spacing between them on an upstream side of a position where the object to be cleaned is placed and each of which has a plurality of upstream passing apertures for passing the cleaning liquid arranged in its plane; and
a downstream straightening plate that is arranged on a downstream side of the position where the object to be cleaned is placed and that has a plurality of downstream passing apertures for passing the cleaning liquid arranged in its plane, and
characterized in that an upstream aperture ratio that is a proportion of area of the upstream passing apertures in the upstream straightening plate is larger than a downstream aperture ratio that is a proportion of area of the downstream passing apertures in the downstream straightening plate, the upstream aperture ratio being set at a value of 10% or more and 25% or less, the downstream aperture ratio being set at a value of 2.5% or more and 10% or less.

2. The cleaning apparatus as claimed in claim 1, characterized in that the upstream passing apertures of one of the upstream straightening plate of the two upstream straightening plates adjacent to each other and the upstream passing apertures of the other upstream straightening plate are arranged in positions shifted from each other.

3. The cleaning apparatus as claimed in claim 1, characterized in that the upstream aperture ratio and the downstream aperture ratio are set according to a coefficient of kinetic viscosity of the cleaning liquid.

4. The cleaning apparatus as claimed in claim 1, characterized in that the upstream straightening plates and the downstream straightening plate are formed of stainless steel having corrosion resistance to the cleaning liquid, respectively.

5. The cleaning apparatus as claimed in claim 1, characterized in that a direction of flow of the cleaning liquid in the cleaning tank is a horizontal direction, and in that an amount of a drop in a liquid level of the cleaning liquid on a downstream side of the downstream straightening plate with respect to a liquid level of the cleaning liquid on an upstream side of the downstream straightening plate is not larger than a specified value corresponding to the cleaning liquid.

6. The cleaning apparatus as claimed in claim 5, characterized in that the amount of a drop in a liquid level of the cleaning liquid is 30 mm or less.

7. The cleaning apparatus as claimed in claim 1, characterized in that the object to be cleaned is a head stack assembly of a hard disc device.

8. A cleaning method for flowing cleaning liquid in a given direction to clean such an object to be cleaned as is dipped in the cleaning liquid, the method comprising the steps of:
flowing the cleaning liquid through a plurality of upstream passing apertures arranged in respective planes of a plurality of upstream straightening plates that are arranged on an upstream side of a liquid flow of the cleaning liquid and vertically to the liquid flow;
flowing the cleaning liquid through a plurality of downstream passing apertures arranged in a plane of a downstream straightening plate that is arranged on a downstream side of a liquid flow of the cleaning liquid and vertically to the liquid flow; and
dipping the object to be cleaned in a liquid flow of the cleaning liquid formed between the upstream straightening plate and the downstream straightening plate, and
characterized in that the plurality of upstream straightening plates are arranged opposite to each other with a spacing between them, and
in that an upstream aperture ratio that is a proportion of area of the upstream passing apertures in the upstream straightening plate is larger than a downstream aperture ratio that is a proportion of area of the downstream passing apertures in the downstream straightening plate, the upstream aperture ratio being set at a value of 10% or more and 25% or less, the downstream aperture ratio being set at a value of 2.5% or more and 10% or less.

9. The cleaning method as claimed in claim 8, characterized in that the upstream passing apertures of one of the upstream straightening plate of the two upstream straightening plates adjacent to each other and the upstream passing apertures of the other upstream straightening plate are arranged in positions shifted from each other.

10. The cleaning method as claimed in claim 8, characterized in that the upstream aperture ratio and the downstream aperture ratio are set according to a coefficient of kinetic viscosity of the cleaning liquid.

11. The cleaning method as claimed in claim 8, characterized in that the upstream straightening plates and the downstream straightening plate are formed of stainless steel having corrosion resistance to the cleaning liquid, respectively.

12. The cleaning method as claimed in claim 8, characterized in that a direction of flow of the cleaning liquid in the cleaning tank is a horizontal direction, and in that an amount of a drop in a liquid level of the cleaning liquid on a downstream side of the downstream straightening plate with respect to a liquid level of the cleaning liquid on an upstream side of the downstream straightening plate is not larger than a specified value corresponding to the cleaning liquid.

13. The cleaning method as claimed in claim 12, characterized in that the amount of a drop in a liquid level of the cleaning liquid is 30 mm or less.

14. The cleaning method as claimed in claim 8, characterized in that the object to be cleaned is a head stack assembly of a hard disc device.
